(19) United States
(12) Patent Application Publication
(10) Pub. No.: US 2006/0003305 A1
(43) Pub. Date: Jan. 5, 2006

(54) Method for generating an on-line community for behavior modification

(76) Inventor: Cheryl May Kelmar, Santa Barbara, CA (US)

Correspondence Address: Cheryl Kelmar, 1210 Del Oro, Santa Barbara, CA, 93109, US

(21) Appl. No.: 10/884,369

(22) Filed: Jul. 1, 2004

(51) Int. Cl. G09B 3/00

(52) U.S. Cl. 434/350

(57) ABSTRACT

A method for creating, maintaining, and participating in an on-line educational and medical community for education and treatment of participants, comprising selecting multiple-component behavioral and psychological strategies pertaining to individuals, families, peer groups, and selected environments and providing access methods to participants for interactive communications within the game setting. Game scripts are translated to electronic instructions, stored on a client and server, for interactive use by participants, and implemented in situational environments in the on-line educational and medical community for education, behavioral modification and treatment of participants.

### CROSS REFERENCE TO RELATED APPLICATIONS

### 37 CF.R.1.77

This application is related to and claims priority from U.S. Provisional Patent Application ‘Buddies OnLine’, 60/474,946, filed Jun. 4, 2003.

### BACKGROUND OF THE INVENTION

### 37 CF.R.1.77(a)(7)

1. Field of Invention

This invention relates to methods for creating, maintaining, and participating in an on-line wellness community for education, behavior modification, medical treatment and social support of participants. More particularly, to an on-line game methodology for multiple players, taking place in a shared virtual space for prevention or to ameliorate development of health risk factors, enhance resiliency and psychological well being, and to enable health education and behavior modification.

2. Description of the Related Art

Numerous methods and strategies have been developed to treat and educate patients about medical conditions, wellness strategies and behavioral modification techniques, both physical and behavioral. The conventional approach has been in clinical, hospital or school settings with interviews, tests, or questionnaires used to determine and evaluate an ailment; or through traditional videos, CD Rom software or Internet content presented in a ‘talking heads’ or lecture educational approach. Such types of screenings and tests are then used to prescribe a therapy, medication, health supplements and strategies, behavior change or a multi-component psychological strategy. Although effective and appropriate in some situations, very often such approaches are extremely expensive and may be less than effective because of lack of compliance. This is especially the case with behavior type problems such as substance abuse including smoking, drinking, obesity, drug addiction, nutrition, wellness, and the like.

Some attempts have been made at using computers, the Internet and wireless technology to assist in diagnosis, treatment, behavior modification, and education of patients. Typically such approaches have used questionnaires, which may be filled out on the computer, or information presented in a ‘talking heads format’ or lecture model on-line about a particular condition, treatment or wellness issue.

Unfortunately, such approaches have not been particularly well received, sufficiently adapted to patient needs or effective due to technical limitations, educational techniques and widespread use and acceptance.

The present invention is a method for creating, maintaining, and participating in an on-line wellness community for education, behavior modification, medical treatment and social support of participants, which is effective, inexpensive to implement, and highly adaptable to a wide variety of situations. More particularly, the present invention is an on-line game methodology, which may be used by one or multiple participants, which takes place in a shared virtual space for prevention, treatment, behavioral modification, social support and education of participants.

Accordingly, it is the primary purpose of this invention to provide a very effective method for creating, maintaining, and participating in an on-line wellness community for education, behavior modification, medical treatment and social support of participants. More particularly, to an on-line game methodology for multiple players, taking place in a shared virtual space to ameliorate development of health risk factors, enhance resiliency, increase psychological well being, modify behavior and to enable health education and medical treatment

Additional objects and advantages of the invention will be set forth in the description that follows, and in part will be obvious from the description, or may be learned by practice of the invention. The objects and advantages of the invention may be realized and obtained by means of the instrumentalities and combinations particularly pointed out in the appended claims.

### SUMMARY OF THE INVENTION

### 37 CF.R. 1.77(a)(8)

A method is provided herein for creating, maintaining, and participating in an on-line wellness community for education, behavior modification, medical treatment and social support of participants, comprising multiple-component behavioral and psychological strategies pertaining to individuals, families, peer groups, and selected environments and providing access methods to participants to engage in interactive communications within a game setting. Game scripts are translated to electronic instructions for interactive games with an adaptable and modular code base consisting of both client and server components, for interactive use by participants in situational environments. Situational environments are implemented in the wellness on-line community for education, behavioral modification, social support and treatment of participants.

The disclosed methodology may be used in a wide variety of treatment and therapeutic situations, including behavioral counseling and self-care methods. Self-care methods such as, virtual 12-step programs, peer support and group therapy, virtual white board meetings and on-line therapy sessions. The methods disclosed herein may also be used for determining a physical parameter and participant profile, and if desired, combined with a monitoring device to determine such parameter and to provide immediate information to the participant.

### BRIEF DESCRIPTION OF THE DRAWINGS

The accompanying drawings, which are incorporated in and constitute a part of the specification, illustrates a preferred embodiment of the invention and, together with a general description given above and the detailed description of the preferred embodiment given below, serve to explain the principles of the invention.

FIG. 1A illustrates a first preferred embodiment of the present invention comprising a computer workstation and a communications network whereby a software program and the communications network enable the execution of a first preferred embodiment of the method of the present invention.

FIG. 1B is a software flowchart of the software program of FIG. 1A

FIGS. 2A and 2B present a flow diagram of a preferred embodiment of the method for creating, maintaining, and participating in an on-line wellness community for education, behavior modification, medical treatment and social support of participants, according to the invention and then software program of FIG. 1A

FIG. 3 is a flow diagram of another embodiment of the methodology, according to the invention and as embodied in the software program of FIG. 1A

FIG. 4 is a flow diagram of an embodiment of the methodology for therapeutic interactive treatment and education in an on-line wellness community, according to the invention and as embodied in the software program of FIG. 1A

FIGS. 5 and 6 is a diagrammatic representation of game server internals, according to the invention, as implemented by means of the communications network of FIG. 1A

FIG. 7 is exemplary screen of a game script, according to the invention and as presented on a video screen of a computer workstation of FIG. 1A

### DETAILED DESCRIPTION OF THE INVENTION

### 37 CF.R.1.77(a)(10)

Reference will now be made in detail to the present preferred embodiments of the invention as illustrated in the accompanying drawings.

In accordance with the invention there is provided a method for creating, maintaining, and participating in an on-line wellness community for education, behavior modification, medical treatment and social support of participants, which is easy to use, highly effective, and easily modified for various wellness, medical and educational situations. The method, in one embodiment, comprises selecting multiple-component behavioral and psychological strategies pertaining to individuals, families, peer groups, and selected environments and providing access methods to participants for interactive communications within the game setting. Game scripts are translated to electronic instructions for interactive games with an adaptable and modular code base consisting of both client and server components, for interactive use by participants, and implemented in situational environments in the on-line wellness community for education and treatment of participants.

In accordance with another embodiment of the invention a method for creating a participatory on-line wellness community for education, behavior modification, medical treatment and social support of participants is provided, comprising utilizing multi-component behavioral strategies, providing access means for participants to participate in an interactive community; using a game methodology for interactive participation and use by participants; and implementing situational environments in the on-line wellness community for education, behavior modification, social support and treatment of participants. Non-player characters may be utilized in this methodology if desired.

In accordance with another embodiment of the invention, a method for therapeutic interactive treatment and education, is provided comprising, implementing multi-component treatment methods in an on-line weliness community; providing access means for participation in the on-line wellness community; utilizing a game method or script with non-player characters for interactive use by participants; and creating situational environments in the line wellness community for education, social support and treatment of participants.

The method of the present invention is an on-line game for multiple players, taking place in a shared virtual space. It is designed to prevent or ameliorate development and health risk factors, enhance resiliency factors and to provide health education and behavior modification techniques. The methodology implements multiple-component behavioral strategies across one or more social systems involving individuals, families, peer groups, and diverse environments. Chat and game play support enrich one another. Conversation is about the game play and is preferable conversation about health, coping strategies, social development and life skills and skills for resisting social influences. A key element is that having access to other players helps provide social support, creating virtual 12 step programs, peer support, group therapy groups, virtual white board meetings, on-line therapy sessions, and the like.

Individual mini-games, locations, non-player characters (NPCs), and situations preferably focus on various specific health topics, with the core game designed to treat all issues within a common framework of common relevant factors. This framework, and the core of game play, is that the players strive to improve traits that help their game characters resist high-risk situations, such as smoking, drinking, substance abuse, obesity, etC and to modify their behavior.

Preferably, the core game models real life character building. Each player controls the actions of an individual character in the game world. The character's “character” (aggregate) is partly defined by scores assigned to various traits, both beneficial, such as resiliency, socialization, and self-esteem and harmful, such as stress and boredom. The player's and the character's actions affect the trait scores. The player gains points of resiliency by succeeding in mini-games that develop and test their knowledge of health risks and social skills; their knowledge of healthy behaviors like good nutrition and exercise; and their decision-making skills. The player gains points of socialization by helping other players.

Preferably, the focal point where all the game elements come together are high-risk situations, in which the player-character is depicted confronting a circumstance such as an offer of drugs or a stressful event that could incite the character to smoke. The high-risk situations are triggered when the player-character moves to certain places, interacts with certain objects in the environment, or encounters certain non-player characters (NPC) that move through the environment in the same way characters do. The player must use the character's resources to overcome the situation, just as players in a fantasy game use their resources to fight monsters. Failing to overcome a high-risk situation results in the player-character losing points, and the like.

The ability to overcome high-risk situations of increasing levels allows the players access to new locations and to new places and activities within locations. Thus, the ultimate reward for mastering the elements of the game that contribute to overcoming high-risk situations is the freedom to interact with more of the world in a more effective way.

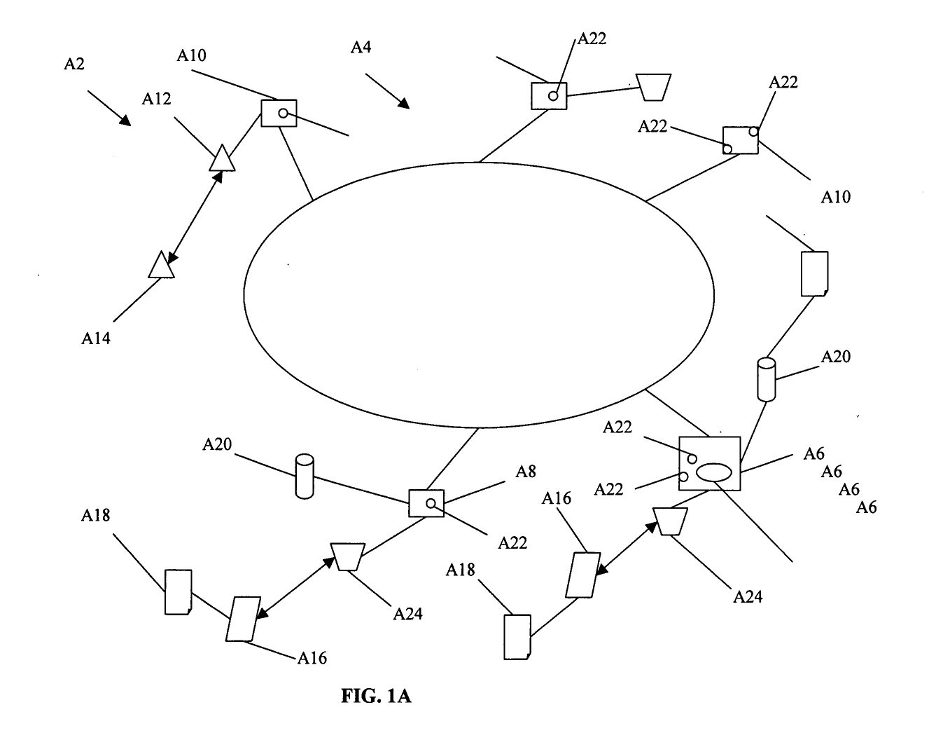

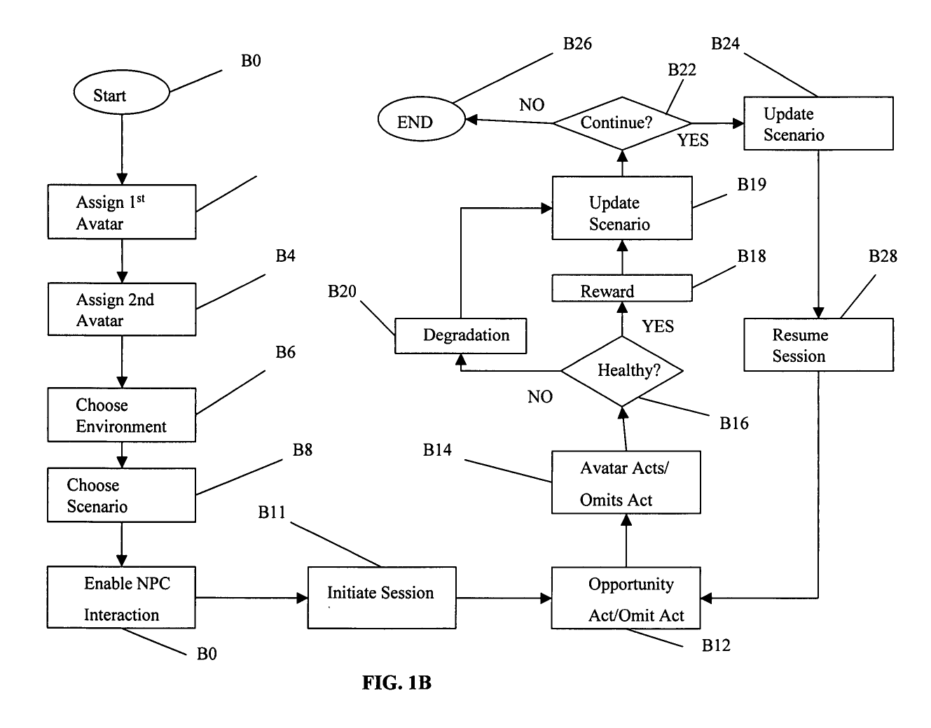

With reference now to the Figures and particularly to FIG. 1A, a communications network A2 comprises a computer network A4, a first workstation A6, a second workstation A8, a plurality of workstations A10, a wireless transponder A12, a wireless computational device A14, and a computer-readable media A16. A software code program A18 may be stored in the computer-readable media A16, or memory modules A20, or distributed among one or more computer-readable media 16, the memory modules A20, and other suitable software code storage systems known in the art. The software code program A18, or software A18, directs the processor(s) A22 of the workstations A, A8, & A10 to enable the execution and/or to execute a first preferred embodiment of the method of the present invention. A computer-readable media player A24 is coupled with one or more workstations A6, A8 & A10 and configured to read the software A18 from the computer-readable media A16 and provide the software A18 to the processors A22 whereby the processors are directed by the software A18, or by a set of instructions derived from the software A18, to implement the first preferred embodiment of the method of present invention via the communications network A4.

The term “computer-readable medium” as used herein refers to any suitable medium known in the art that participates in providing instructions to the network for execution. Such a medium may take many forms, including but not limited to, non-volatile media, volatile media, and transmission mediA Non-volatile media includes, for example, optical or magnetic disks, such as storage device 10. Volatile media includes dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read. Various forms of computer readable media may be involved in carrying one or more sequences of one or more instructions to the network for execution. For example, the instructions may initially be carried on a magnetic disk of a remote computer. The remote computer can load the instructions into its dynamic memory and send the instructions over a telephone line using a modem. A modem local to or communicatively linked with the network can receive the data on the telephone line and use an infra-red transmitter to convert the data to an infra-red signal. An infra-red detector can receive the data carried in the infra-red signal and appropriate circuitry can provide the data to the network.

The wireless transponder A 12 enables bi-directional communication between the wireless computational device A14 and the second workstation A8, whereby a participant in an on-line community enabled by the first preferred embodiment of the method of the present invention may participate in the on-line community by using the wireless computational device A14. The wireless device A14 is an optional element of the communications network A2 and computer network A4. The communications network A2 and the computer network A4 may be comprise an electronic communications network, the Internet, an intra-net, and extra-net, and/or other suitable communications networks known in the art.

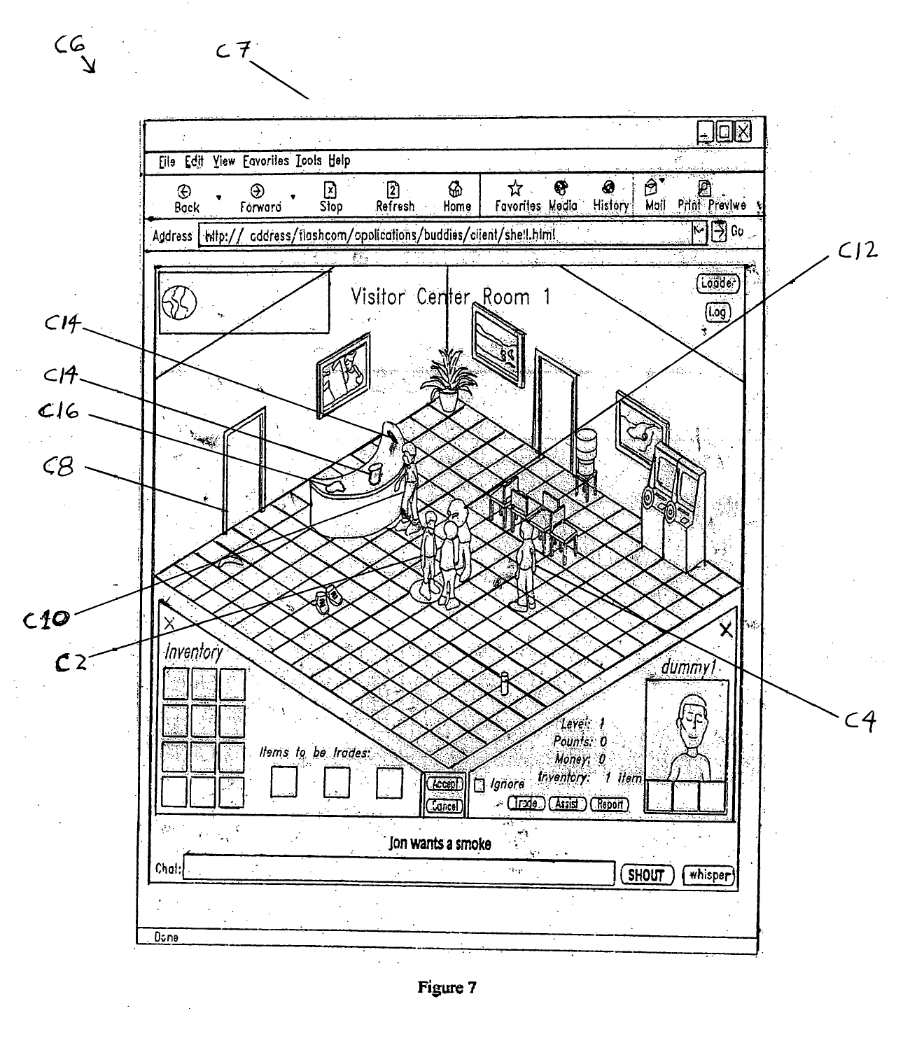

Referring now to the Figures and particularly to FIGS. 1A, 1B and 7, FIG. 1B is a software flowchart of the first preferred embodiment of the method of the present invention. In step B2 a first avatar C2 is assigned to a first user. In step B4 a second avatar C4 is assigned to a second user. In step B6 a software environment C6 is chosen by the participants, or selected by the software 18. The environment C6 of the first preferred embodiment is pictured in FIG. 7 as viewed within a participant's dashboard C7 as presented on a video screen A28 of FIG. 1A The environment C6 includes a simulation of recreation room C8, wherein a visual representation of the first avatar C2, the second avatar C4, a first non-player character C10 (“1^{st} NPC”), a second non-player character C12 (“2^{nd} NPC”), a plurality of objects C14 and a substance C16 are provided by means of the video screen A28. In step B8 of FIG. 1B a scenario is selected. The scenario may be provided by the software 28 as a software script and may, for example, simulate a discussion among teammates or friends about a preciously played or up-coming sporting event. In optional step B10 the 1^{st} NPC C10 and 2^{nd} NPC C12 are enabled to interact with each other, the first avatar C2, the second avatar C4 and/or other avatars or non-player characters. In step B11 a session of the scenario is initiated, whereby the first participant is enabled by means of the communications network A2 to direct the simulated actions and behavior of the first avatar C2, and the second participant is enabled by means of the communications network A2 to direct the simulated actions and behavior of the second avatar C4. In step B12 the 1^{st} NPC provides an opportunity to the first avatar C2 to perform a health affecting act, such as to accept and smoke a cigar C14, to drink a vitamin rich drink C16, or ingest or inject the substance C16 into the first avatar C2. In step B14 the first avatar responds to the 1^{st} NPC out an instruction by the first participant to perform or not perform, within the context of the simulation of the software 28, a healthy or unhealthy act. In step B16 the software 28 determines if the instruction received from the first avatar in step B14 indicated a choice to behave in a healthy manner, e.g., to not smoke the cigar or to drink the vitamin rich beverage, or a less healthy or unhealthy manner, e.g., smoke the cigar or not ingest the vitamin rich beverage. If the first participant indicated a healthy response, than the software 28 proceeds to step B18 wherein the first participant receives a reward. The reward may, for example, be an improvement in a numerical or graded score, or an increase in the capabilities or status of the first avatar C2. If the first participant indicated a less healthy or un healthy response, than the software 28 proceeds to an optional step B20 wherein the first participant receives an undesired outcome, such as receiving a demerit, a degradation of in a numerical or graded score, or a reduction in the capabilities or status of the first avatar C2. It is understood that the virtual substance C16 may be or comprise a representation of a substance containing or composed of alcohol, a narcotic, and/or an addictive substance. In step B22 the software 28 determines if the scenario is to be continued. If the scenario is not to be continued, then the software 28 ends the instant session of the scenario. If the scenario is to be continued, then the software 28 updates the scenario with information derived from steps and returns to executing the instant session of the scenario.

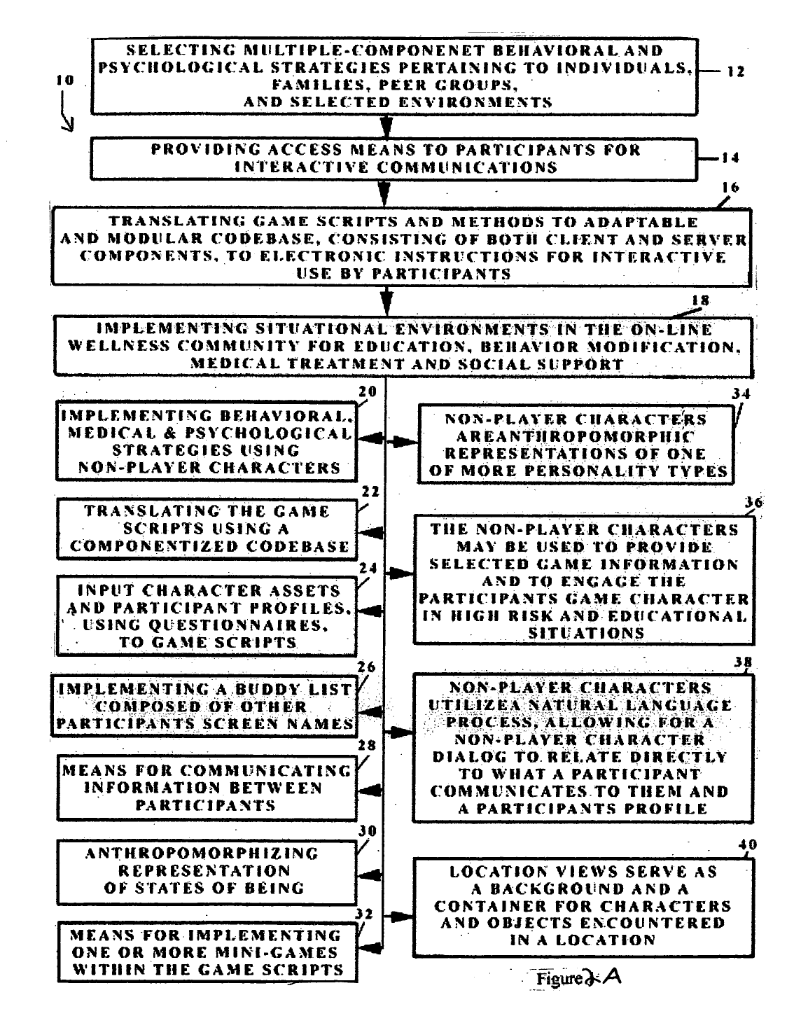

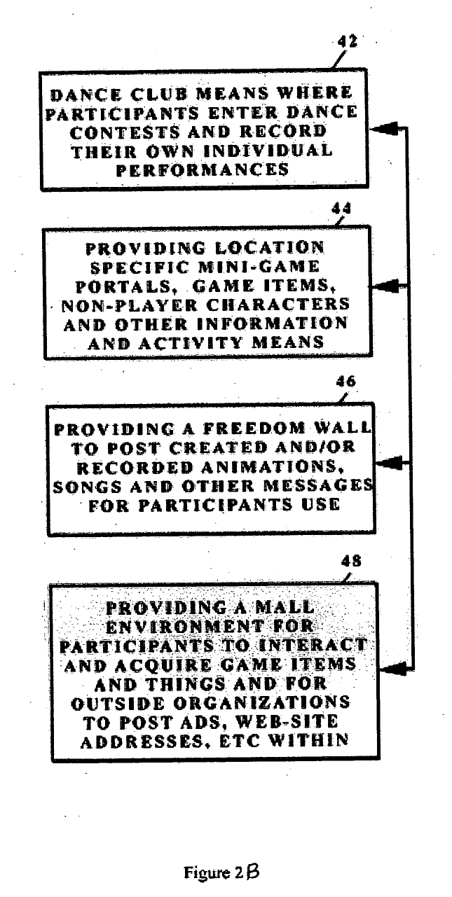

Referring now to the Figures and particularly to FIGS. 2A and 2B, a method for creating, maintaining, and participating in an on-line wellness community for education, behavior modification, medical treatment and social support of participants 10 is shown comprising the steps of, selecting multiple-component behavioral and psychological strategies pertaining to individuals, families, peer groups, and selected environments 12, providing access means to participants for interactive communications 14, translating game scripts and methods to adaptable and modular code base, consisting of both client and server components, to electronic instructions for interactive use by participants, and 16, and implementing situational environments in the on-line wellness community for education, behavior modification, medical treatment and social support of participants 18.

The method preferably includes the step of implementing behavioral, medical, and psychological strategies using non-player characters 20, and translating said game scripts using a componentized codebase 22.

According to the preferred method, participants input character assets and embedded questionnaires create participant ‘profiles’ to the game scripts 24, and may implement a buddy list composed of other participants screen names 26. The method allows for communicating information between participants 28, and, anthropomorphizing representation of states of being 30.

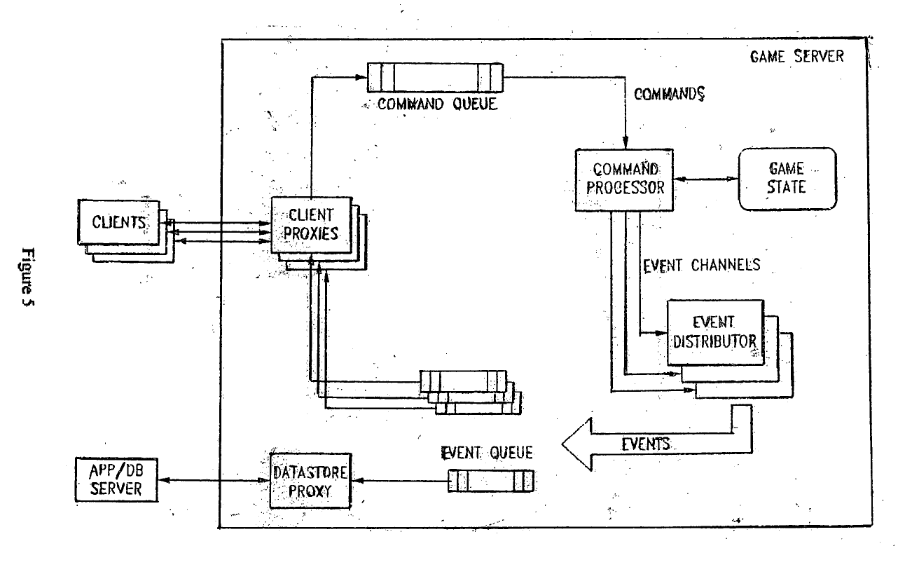

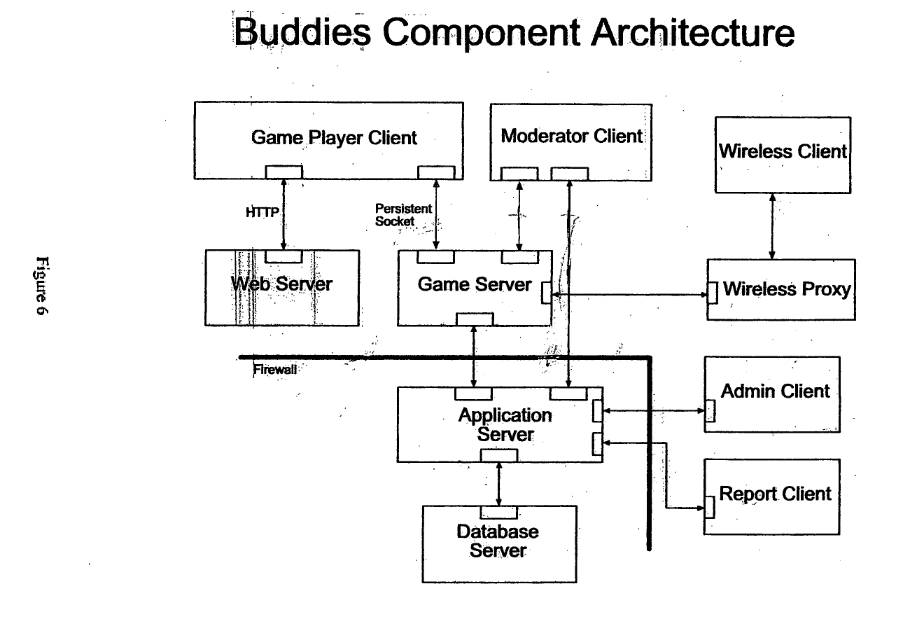

Means for implementing one or more mini-games within the game scripts 32, are proved and non-player characters are anthropomorphic representations of one or more personality types 34. In FIGS. 5 and 6, a schematic representation of preferred game server internals are shown. The non-player characters may be used to provide selected game information and to engage the participants game ‘character’ in high-risk situations 36, and may utilize a natural language process, allowing for a non-player character dialog to relate directly to what a participant communicates to them and a participant's profile 38.

In the preferred method, location views serve as a background and a container for characters and objects encountered in a location 40, and various activities such as. a dance club means where participants enter dance contests and record their own individual performances 42, location specific mini-game portals, game ‘items’, non-player characters and other information and activity means 44, a mall environment for participants to interact and purchase game items and things and for outside organizations to post ads, web-site addresses, etC within 48, and a Freedom Wall to post created and recorded animations, songs and other messages for participants use 46, as well as other interactive activities are provided.

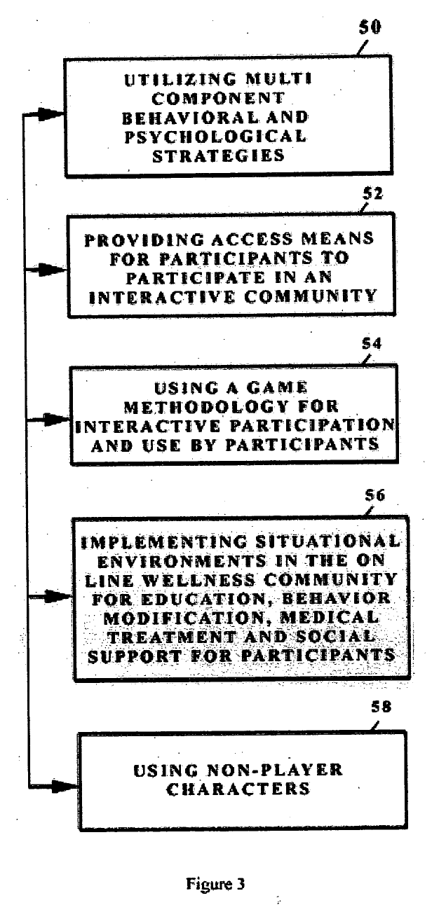

In FIG. 3, another embodiment the preferred methodology for creating a participatory on-line wellness community for education, behavior modification, medical treatment and social support of participants, is schematically represented comprising the steps of utilizing multi-component behavioral and psychological strategies 50, providing access means for participants to participate in an interactive community 52, using a game methodology for interactive participation and use by participants 54, implementing situational environments in the on-line wellness community for education, behavior modification, medical treatment and social support of participants 56, and utilizing non-player characters in the interactive method 58.

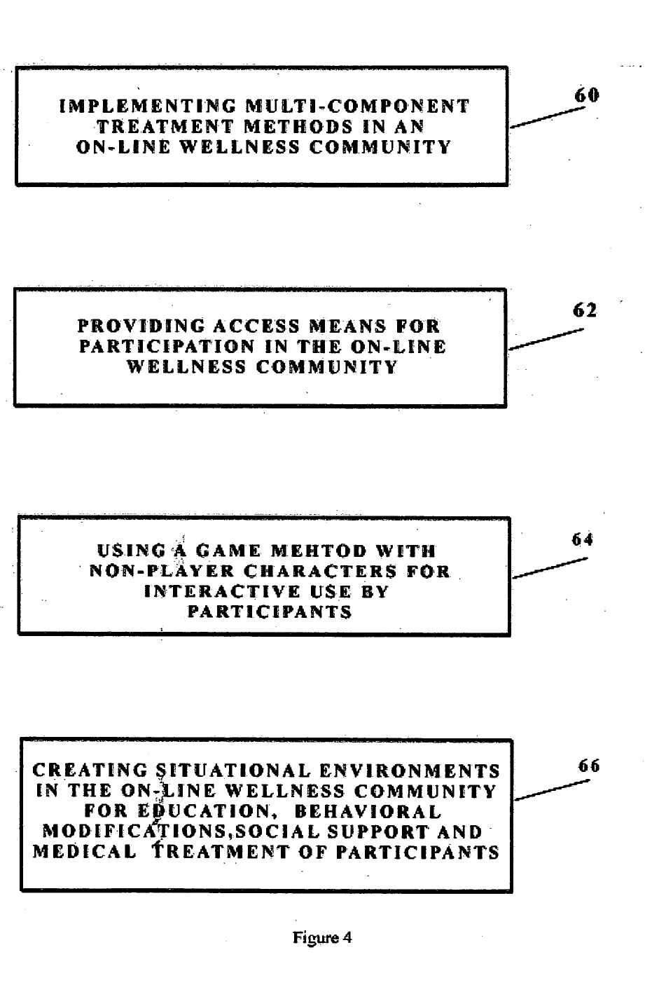

Referring now to FIG. 4, another embodiment of the preferred methodology is shown for therapeutic interactive treatment and education in an on-line wellness community, comprising the steps of implementing multi-component treatment methods in an on-line wellness community 60 as detailed below; providing access means for participation in the on-line wellness community 62, using a game method with non-player characters for interactive use by participants 64, and creating situational environments in the on-line wellness community for education, behavior modification, social support and medical treatment of participants 66.

According to the preferred method, the user first signs in. The game is preferable entered from a Web page containing appropriate information about the game. The game window contains a sign-in field in which the player must enter a password to continue. An example of a game window is shown in FIG. 7.

Preferably, players use embedded questionnaires as they enter the game to provide their health indicators, social parameters and the like. Such information determines a participants profile and must be updated each time they resume play. These health indicators and social parameters might include substance abuse, physical activity, overweight and obesity, tobacco use, responsible sexual behavior, injury and violence, mental health, environmental quality, and the like. The information within these questionnaires are preferably used throughout game play; affecting the game score, status, non-player character interaction, high risk situations, levels, game variables and other interactions.

In the preferred methodology, a level is determined for each player. Each player contains a profile. The character profile is used in the game to determine level, high-risk situation, locations the player can access, and the like. The level of a player affects their health status and game play variables, and is a function of game play and their questionnaire responses. On each level there will be specific educational topics, questions, mini-games, dynamic mini-games, items to win, high-risk situations, an ending quiz, and the like.

A database for assessment and record keeping is preferably included. Data from the questionnaires, game play and the player's profile is stored in a database for assessment and record keeping and tracking.

In the preferred embodiment, character creating is a part of the methodology. For example, the first time a player enters the game world the player begins in the character creation screen. Players can import character assets to the game following specific technical requirements. Once the assets are imported they will be a permanent part of the game. This allows for players to trade character features on e-commerce sites on the Internet. The player enters a fictitious screen name for the character.

An information panel preferably displays images and text information describing any character, for example, a player-character, monster (a type of non-player character), or other NPC, item or object visible in the current location. It also provides an additional way to interact with characters, items and things in the same way that the command buttons and special cursors do. The exact information displayed depends on the type of character or object selected.

A player profile may include a picture of the character, in a magnified view showing the character's current wardrobe, which includes apparel, jewelry, accessories and body modifications. The character's screen name, the character's level, the number of items in the character's inventory, the character's health and knowledge profile, and the character's “personal”, a text description similar to the self-descriptions in personal ads, composed of adjectives earned by gaining levels, may be included. Other information obtained through questionnaires, puzzle, and a Buddy List, are further examples of such information.

Preferably, each player has a puzzle. As the player progresses through the game, they are provided with puzzle pieces through NPCs. The determination of when a player receives a puzzle piece is based on the player's profile information. Each player will need to complete his or her puzzle in order to post on the Freedom Wall and to complete the game.

A player can contact a moderator for “Abusive or offensive behavior by another player”, “Game is not working properly”, and the like.

The method may include an “Ignore This Player/Do Not Ignore” toggle. For example, a player-character can add a player to a list of players they wish to ignore. Players on a player's ignore list do not see chat from the ignored players, cannot receive any type of message from the ignored player, cannot receive help from that player for smoking urges, for example, and cannot offer to trade or receive offers to trade from that player.

For navigation within locations, players preferably move their characters from place to place within a room by clicking on locations where the character may stand or sit. Floor positions, such as grid squares, where a character may stand or sit highlight when the cursor is over them. The highlighted floor position preferably appears as a square the size of one unit of the underlying position grid, regardless of whether or not the floor texture at that position has a visible square pattern normally.

When at rest, each character occupies one floor position, which cannot be the occupied position or destination of any other character. When moving, each character has a destination position, which cannot be the occupied position or destination of any other character. When the player clicks a position, the server is polled to determine whether the position is still available. If it is not, the local program provides negative feedback, for example, a short buzz, and un-highlighting the clicked position.

An exception to the previous rule is that positions immediately outside doorways, exits from the location, are always clickable. While they can be the destination for character movement, they are never considered occupied by a character. Characters moving to a position outside a doorway disappear upon reaching it.

Preferably, intermediate movement of characters from place to place is conducted at the server side on a regular cycle. At the start of each cycle, the server updates each local program with the current position of each character, and the position, if any, the character is moving to. This information allows the local program to catch up with the current state of the room if packets have been delayed or lost. The local program preferably handles the animation of movement during the cycle.

In the preferred method, characters move by walking from square to square. The server calculates a path, which is based solely on the permanent layout of the room, regardless of where other characters are currently standing or walking. Characters follow that path until they reach their destination. Positions where characters can sit are preferably not available for movement paths, but can be destinations.

Preferably, the chat from a character is suspended and floats upward when the character begins moving. No new world balloons appear for the moving character until the character reaches a stationary destination.

A moving character can move past a stationary character or another moving character while in transition. Slightly compressing the width of both characters, and shifting them within the square in the appropriate directions animate this. These are algorithmic transformations and require no additional character art assets to animate these events.

Preferably, there are twelve different patterns for a moving character to move part a stationary character. However, other numbers of patterns may be used. With twelve patterns, the arrangement allows four different directions from which to enter the square, times the three possible directions the character can leave the square without reversing direction. There are also four additional cases in which a moving character reverses direction while in the process of moving past a stationary character, due to a destination change while the character is still in transit.

The above mentioned rules have the following that characters standing in place, or moving, do not block access to doors or parts of the room, and a character cannot be trapped or hemmed in by other characters.

However, characters standing in place can block other character's access to specific positions. For example, four characters standing around an NPC can prevent any other character from moving adjacent to that NPC; however, they preferably cannot prevent the NPC from moving.

In the preferred method, movement deadlock conditions are not possible. Characters cannot bump into walls or obstacles, because the players are not “steering” the character's movements step by step as in a video game. Rather, they are used to set the destination position.

Preferably, movements are visible to all other players in the same location. The movements occur within the space the character is standing on. Three such types of moves include: dance moves, gestures, and defensive moves.

Each gesture expresses a simple basic emotion, such as happiness or celebration. For example, a character raises arms and jumps up and down. For anger, a character may stomp and pound arms, or stands akimbo. For sadness or regret a character may bow head, slumps shoulders or wraps arms. For surprise or fear a character may rear back and its eye's go wide. For “just kidding” a character may shrug, hands out, turns head away, smiles, and the like. For agreement, a character nods head yes, and for disagreement a character nods head no. For stop gesture, the character may return to normal.

Defensive moves can be used anywhere, for example, when confronting a monster. One such defensive move is a “shield” a “shield” transparency surrounds a player for defense against a monster or other attack.

In the preferred method, chat is text that is typed by players and distributed by the server so as to immediately appear on other player's game screens, as a mode of real-time conversation. Player to player chat is preferably displayed on screen using word balloons.

Players can chat with any character in the same location that they are in, and can see all normal chat by other players within that room. Players who wish to converse more privately, which are common in all types of public chat spaces, can opt to “whisper” which allows their chat to only be heard by players whose characters are adjacent to them.

Chat is filtered to screen out obscene and abusive language insofar as possible. All players have the ability to set an “ignore toggle regarding any other players they wish. Ignored player's chat does not appear on the ignorer's screen. Players are encouraged to report incidents of offensive or abusive language, or other violations of the site's policy, to the game moderators.

Word balloons are individual units of chat text from player characters, NPCs, and monsters. Players usually type player character's chat in. Monster and NPC chat is preferably program controlled. Each word balloon appears centered above the character that uttered it. Word balloons follow the player and are aged using transparencies as they float upward; making room for each new balloon.

In the preferred embodiment, Buddy Lists are part of the player's profile. The player composes the list, adding other player screen names to the list. Buddy lists can be transferred to other devices, including wireless devices.

Items are small portable objects that represent coping strategies, cessation skills or other educational and health metaphors. Most items are carried by player-characters as part of their inventory, and therefore do not appear in the location view itself. However, items can be dropped by players or can be placed within locations by the program. Player-characters can pick up items.

Preferably, all items represent elements of knowledge. Some represent real things that are actually directly usable in the real word, such as a bottle of water. Others are more abstract and represent areas of knowledge acquired.

Active items are placed at certain locations by the program. They appear as ordinary items, but are never put into a player's inventory. If a player picks one up, it triggers a player response in the form of a cessation urge, action, etC

“Things” are stationary objects within locations that have interactive functionality that is initiated by clicking on them. The player's character must be standing adjacent to a thing to activate any of its functions, but information about a thing can be obtained by clicking on it from anywhere in a room. Using some things, for example, a public phone, which sends instant messages to other players, can also initiate a player response. A player's inventory is the player's current collection of items.

Upon its generation as an item instance, such as a “prize” awarded by a mini-game, an item is invested with a random number of charges. The number of charges controls how many times the item can be used before it is used up. Preferably, every use eliminates one charge.

A player who is attacked by a monster or other character can lose some of his entire inventory. Some NPCs cause players to lose items because the player interacted with them.

A player may obtain items by, for example, playing and winning mini-games, picking them up from the environment such as loose items, trading with other players, and interacting with certain NPCs and Things.

Players can trade items with each other freely. Players can chat about a trade they want to make from anywhere, but they have to “get together” to make a trade. A trade is only made when both parties have accepted identical trade terms.

Preferably players may give or use items to: Help deal with other player's, and their own, smoking urges. Chase off and defeat monsters. Gain access to blocked off locations. Trade with players or NPCs and Things, for other items. To use the item in interaction with a Thing, for example, a key is used to open a door. To give the item to a Thing, for example, throw an item into a trashcan. To give the item to an NPC, possibly with the exception of something in return. To use the item to fend off or defeat a monster. To give the item to deal with another player's smoking urge, for example.

Selected items may be dropped, removing them from inventory and causing it to appear on the space the player-character is currently standing.

Interaction with some Things involves inventory items. For some Things, items can be “used” to activate the thing; for others, items must be “given” to the thing, which removes them from the player's inventory.

In the preferred methodology, Things may have interfaces. Some Things have their own controls that appear when the Thing is clicked on. For example, the mailbox on the Street has buttons for sending various types of messages to other players, Buddy Mail, Coded Message, or Psychic Message. Other types of Things with interfaces include dispensers allowing items to be purchased for money.

The preferred methodology uses Non-player characters (NPCs) that are characters that appear similar to the player characters, but are controlled by the program. Non-player characters preferably have a human appearance. Their program-controlled utterances appear in balloon chat just as the player's chat does. Some NPCs are bound to a location, such as always hanging out at the arcade. Others wander around and can appear in multiple game locations. NPCs are anthropomorphizing of certain personalities.

In the preferred methodology, some NPCs serve as helpful resources to the player, offering good advice, encouragement and tangible rewards. NPCs specialize in different areas of game information. Some NPCs may actively attempt to sabotage players. Other NPCs are just idiots who make such stupid comments that the only reasonable thing for the player to do is “reject” them. The “reject” mechanism consists of sending a NPC through a trap door in the floor, for example.

NPCs can give and take items with the player characters in a one to one trade. Puzzle pieces are preferably given to player characters, based on player profile. NPCs are preferably represented as intelligent possessing a natural language processing (NLP). The NPCs dialog is dynamic and tailored to what a player says directly to them and the player's profile. The preferred dialog algorithm uses sentence and grammatical parsing. NPCs may wander on the screen; preferably all NPCs enter a location by walking through the door. After reaching his destination square in the room he waits. At the end of the wait cycle the NPC walks to a new spot in the room, and waits. While waiting the NPC makes a “conversation check”.

Attitude NPCs are human figures that enter a location, walk randomly from place to place in that location and spout out nonsense every time they stop moving. They say things such as: “I'll quit smoking in my thirties.” “Yeah smoking kills. But I'm gonna die anyway.” “I'm not addicted. I smoke because I like it.” “So smoking is expensive. So what? And the like. The players can “reject” these NPCs and receive a cash reward.

More complex scenarios may be presented as miniature dramas that portray a situation that can cause the player's character, or in some cases an NPC, to be at risk, to learn, or the like. The more complex scenarios may be used based on rules that take into account a variety of factors including the current phase of the player's cessation attempt, the player's game level, the player's motivation ratings, the time since the last scheduled event for that player, the time since the last event occurring in the location, the current location of the NPCs and other health issues. These situations require the participation of one or more of the wandering NPCs. NPCs display cessation urges, health reactions, story lines, and dramas as a way to educate and/or present ideas to the player. Part of the story lines or dramas includes the NPCs being the character that is quitting smoking or experiencing health difficulties. This will allow the player to learn about health issues by helping a NPC, versus their player character experiencing the health issues directly.

In the preferred methodology, Monsters are characters that have a non-human appearance. They are surreal personifications or effects of cessation issues and states of being, like withdrawal symptoms, attitudes, self-esteem issues, emotions and peer pressure. Monsters are anthropomorphizing of states of being. Monsters may attack player-characters, with various consequences including losing inventory items. Players can fend off or destroy monsters using items from their inventory, defensive moves and shields.

In general terms, there are two levels of effect of dealing with any Monster: fending it off, and defeating it. Which, if either, occurs depends on which item is used. Players can also fend off monsters by using defensive moves and/or a shield earned. If the player is attacked and fails to fend off or defeat the monster, the player character will take on the Monster's head. This is to represent that the player is experiencing the same state of being for which the particular Monster represents.

Preferably, a Map screen provides global navigation to the game locations. Clicking the name or image of a location takes the player to the location. In the preferred methodology, the game world has a plurality of locations, for example, 10 main locations. This number can be expanded or reduced if desired. Examples of locations include:

| | |
|---|---|
| Arcade | Movie Theater Lobby |
| Street | Mall |
| Maria's House | Ty's House |
| Café | The Studio |
| The Performance Space | Health Club |

Each location is preferably viewed from an angle of about 30 degrees looking down. However, this may be changed to a higher or lower level if desired. The static elements of the location are the floor, walls, doors and furniture, the latter including outdoor objects like mailboxes or trees in outdoor locations. This provides a virtual space on which characters, non-player characters (NPCs), monsters, and loose items are positioned. The view is preferably orthogonal, with no vanishing-point perspective. The “camera” is fixed; the view cannot, in the preferred embodiment, be elevated, rotated, panned or zoomed.

Preferably, specific positions at each location are designated as entrance and exit points. Player characters, NPCs, and some monsters enter locations by first appearing on entrance/exit points and then moving to another position. Player characters leave locations by moving to an exit points. NPCs and some monsters can also leave this way, if not rejected or defeated by player characters. Different locations can have different numbers of entrances or exits.

Accordingly, location views serve as background and container for interactive characters and objects that are encountered in the locations, such view may include embedded communications such as sponsored ads and video and audio which can be embedded throughout all the locations if desired.

The preferred methodology may include a Studio, which is a dance club theme as, for example, an “American Bandstand” style TV studio or other musical theme. In a preferred embodiment, the Studio is one large dance floor with a stage at one end where the DJ stands at this table. Racks of CDs are beside him. At the top of the screen there is a Studio light ball. At the Concert characters can enter dance contests and record performances. Of course, other music and/or themes may be represented such as rap, jazz, rock, bluegrass, or the like.

Support activities for players include “peer support”, “virtual 12 step program”, “virtual peer counseling” and “virtual group therapy”.

An interior wall, the Freedom Wall, preferably contains the most recent posted names and recorded messages or performances by players who have completed the game and stayed off cigarettes, other substance, or completed a medical treatment or educational program.

A Performance Space is preferably included and serves three purposes. In the performance space it is the players who create and perform skits, dramas, poetry, animation, music rap, dance, or whatever creative expression the technology and the player's creativity allows. This can be done individually or as a team, on their own initiative. It allows players to record such performances as their legacy to be displayed on the Freedom Wall when they complete the game. And it provides a venue for scheduled public events in the virtual world.

In the preferred embodiment, a virtual Mall comprised of vendor tables and the program provides sponsored created virtual stores. Players use their money to buy features for their on-line player character and to acquire sponsor coupons for real life merchandise.

In the present method, mini-games are standalone games that players enter and play from within the core game world. Mini-games are preferably run in their own windows. When a player enters a mini-game, the player's character leaves the location and the player's screen returns to the map view. Items and health and knowledge points are acquired from the mini-games and are used within the on-line community. The skills taught in these mini-games provide for specific skill building and knowledge, which is related to the on-line game communities main topic, be it medical treatment, behavior modification, substance abuse, or the like. Because player's tastes vary widely, subject matter can appear in many different types of games.

For example, basic single player games such as Concentration, Hangman, or Psychic Messages that players decode using a responsive Ouija-like letter board that gives subtle clues about the next letter. Or, a single player web-arcade-style games such as a Tetris-like block-stacking game may be used. Other examples include two player competitive games such as a car chase game through city streets, or a cross-country road trip and scavenger hunt where player's cessation skills can help avoid obstacles, or creative community building activities, which are games, and activities that engage the player's creativity, allowing them to perform or create for each other. Such activities require ongoing moderator input, by providing new material on a regular basis and/or by directly getting involved in play.

Various reward mechanisms may be used in the present method. For example, players obtain money and levels, small increments of progress toward higher levels, by, using items to help deal with other player's smoking urges, using items to stop or defeat monsters, or by rejecting bad-attitude NPCs.

In the preferred methodology, levels are valuable to players because they confer immunity to certain Monsters, while attracting the attention of other more advanced monsters, they may open up locked areas and new mini-games or new levels of mini-games, they may cause good NPCs to give the player respect, greeting them when entering rooms, and good NPCs will teach the player new moves at each level of status and play.

For example, money can be used by players to buy wardrobe items that appear in the magnified view of the character's appearance, accessories that appear on the character's figure, such as cool shades, which can be a form of status, or bling components, which are letters, symbols, and jewels that each player-character wears.

Reward mechanisms in computer games fall into several possible categories, including effectiveness, social, and creative. Effectiveness rewards are probably the most traditional ones. Typical effectiveness rewards in computer games include items, scores, points, new powers or movements, improved defenses, and access to new playing locations.

Social rewards are particularly important for MMP environments. The three preferred social rewards within present methodology comprise communication, buddy system, and recognition. “Communication” is preferably implemented through chat and e-mail.

Creative rewards are utilized to facilitate a player's ability to create or express something of intrinsic interest within the game. The game allows players to create their own virtual spaces, with the added element that other players can visit and view these spaces and regard them as expressions of the creators resourcefulness and style; create animation, music, poetry, and the like. Participants may use music, animation, character movements and text to create counter messaging. Participants creations may be posted on the game environment's built-in publishing space termed herein, the Freedom Wall.

In the preferred methodology, completing the game allows players to post their name and a recorded performance on the Freedom Wall in The Studio. The player receiving all pieces of their puzzle determines completion of the game. Upon game completion, players are not required to leave the game. They can continue to play and support other players. In addition, the players may go to an entertainment only location space where they can build their own locations.

In operation and use, the following are examples of some representative applications.

Cessation Model

In the cessation model, the core game is based on representing the three different motivations for smoking or other substance abuse such as alcohol or drugs, that can make cessation difficult: addition, habituation, and psychological dependence.

Preferable, the core of the game play is to deal with “smoking urges” brought on by physiological, environmental, and psychological factors. In the original treatment, “smoking urges” specifically represented nicotine cravings.

Addiction is preferably represented in the main game by timed nicotine cravings that cause smoking urges, and by the attacks of the Monsters representing withdrawal symptoms. The frequency of nicotine cravings for a given player-avatar depends on the player's self-reported nicotine usage, for example, heavier smoking equals more frequent cravings, and by the player's “addiction” rating from the questionnaire data, that is, the higher addiction rating equals more frequent cravings.

Preferably, habituation is represented in the smoking triggers in the game environment and by some of the high-risk situations. Environmental smoking triggers include watching TV, using telephones, being near smoking NPCs, talking to individual NPCs, drinking caffeinated beverages, waiting to enter a mini-game, such as waiting for a ride in the street location, waiting in line in the Theater Lobby, playing video games in the arcade, or just standing around for a long time.

Psychological dependence is preferably represented in most of the high-risk situations. Either a non-player character, or the player's character, when faced with a high-risk situation, may get a psychological smoking urge. The frequency that such situations occur depends on a player's psychological dependence rating.

The present methodology places a balanced focus on many different but interconnected risky behaviors and health issues, including smoking, initiating and/or participating in violence, criminal activities, alcohol abuse, sexual activity, and drug abuse, and the like.

For example, a trashcan is a Thing players can “give” items to, thus throwing them away. Some Things can give items back. Other examples of NPCs in situations: a NPC pushes your player at the arcade; smoking friends approach the player; parents yell at the player or at each other; a NPC tells the player that they flunked a test at school; a sports NPC offers a player a cigarette; or a NPC flirts with the player or with another NPC who is flirting with the player.

NPC story lines or dramas may include the NPCs being the character that is quitting smoking or experiencing health difficulties. This will allow the player to learn about health issues by helping a NPC, versus their player character experiencing the health issues directly.

In other aspects of the invention, a player enters the performance Space from, for example, the movie theater lobby. On the stage there is a big sign that says, “Start here”. When a player clicks on “start here”, a window opens and he is told in text and audio how to become an actor on the stage and/or create their performance.

A further example of a mini-game portal according to the present invention: A bus stop shelter, located on the street. If a player-character waits at the bus stop for fifteen to forty-five seconds, a bus drives in along the street, stops at the shelter, and picks up the player-character. This leads the player to the driving mini-games.

The term “workstation” is defined herein, and as related to workstations 6, 8 & 10 of FIG. 1A, to include a computational engine, such as a personal computer or portable computing device, capable of supporting or enabling participation in the scenario, or other scenarios, as discussed in reference to the Figures and particularly in reference to FIG. 7.

Other examples of elements which may be used in game completion: Some of the status elements can be used in the performance in some way, for example, wardrobe items as propos, dance moves, and possibly money if props or scenery elements are for sale, and players can involve their friends as well. Any type of performance, including rap, drama, poetry, and dancing, can be created and recorded, for others to view at the Freedom Wall.

As is evident from FIGS. 1-7 and the above description, a wide variety of on-line educational and medical applications and systems may be envisioned from the disclosure provided. The methodology described herein is applicable in any behavioral, psychological, educational or medical treatment and education system, and additional advantages and modifications will readily occur to those skilled in the art. The invention in its broader aspects is, therefore, not limited to specific details, representative apparatus and illustrative examples shown and described. Accordingly, departures from such details may be made without departing from the spirit or scope of the applicant's general inventive concept.

What is claimed is:

1. A method for interaction of a user in a scenario of an on-line community, the scenario for modifying the behavior of the user, the method comprising:
providing an avatar, the actions of the avatar commandable by the user within the scenario of the on-line community;
the scenario presenting a representation of an environment conducive to an undesired act of the user; and
enabling the user to direct the avatar to perform and to not perform the undesired act.

2. The method of claim 1, the method further comprising rewarding the user with a positive outcome when the avatar does not perform the undesired act.

3. The method of claim 1, the method further comprising providing a first NPC within the scenario.

4. The method of claim 3, wherein the first NPC interacts with the first avatar within the scenario.

5. The method of claim 1, wherein the undesired act is a representation of an act that degrades a state of health of the user.

6. The method of claim 5, wherein the undesired act is an addictive behavior.

7. The method of claim 5, wherein the undesired act is an act of ingesting nicotine.

8. The method of claim 5, wherein the undesired act is selected from the group of acts consisting of drinking a substance, eating a substance, ingesting alcohol, ingesting a narcotic, ingesting an addictive substance, introducing a narcotic into a bloodstream, and introducing an addictive substance into a bloodstream.

9. The method of claim 3, the method further comprising:
providing a second NPC, the second NPC for interacting with the first avatar within the scenario; and
the second NPC comprised within the on-line scenario conducive to an undesired act of the user.

10. The method of claim 3, the method further comprising:
providing a second NPC, the second NPC for interacting with the first NPC within the scenario; and
the second NPC comprised within the on-line scenario conducive to an undesired act of the user.

11. A method for interaction of a first user and a second user in an on-line community scenario to modify the behavior of at least one user, the method comprising:
providing a first avatar, the actions of the first avatar within the on-line computer game scenario commandable by the first user;
providing a second avatar, the actions of the second avatar within the on-line computer game scenario commandable by second the user;
enabling the first avatar to interact with the second avatar within the computer on-line community scenario;
the on-line community scenario presenting a representation of an scenario conducive to an undesired act of the first user;
enabling the first user to direct the first avatar to perform and to not perform the undesired act; and
rewarding the first user with a positive outcome when the first avatar does not perform the undesired act.

12. The method of claim 11, the method further comprising providing a first NPC within the scenario.

13. The method of claim 12, wherein the first NPC interacts with the first avatar within the scenario.

14. The method of claim 13, the method further comprising:
providing a second NPC, the second NPC for interacting with the first avatar within the scenario; and
the second NPC comprised within the on-line scenario conducive to an undesired act of the user.

15. The method of claim 13, the method further comprising:
providing a second NPC, the second NPC for interacting with the first NPC within the scenario; and
the second NPC comprised within the on-line scenario conducive to an undesired act of the user.

16. The method of claim 5, wherein the undesired act is an addictive behavior.

17. The method of claim 5, wherein the undesired act is an act of ingesting nicotine.

18. The method of claim 5, wherein the undesired act is selected from the group of acts consisting of drinking a substance, eating a substance, ingesting alcohol, ingesting a narcotic, ingesting an addictive substance, introducing a narcotic into a bloodstream, and introducing an addictive substance into a bloodstream.

19. One or more processor readable storage devices having readable code embodied on the processor readable storage devices, the readable code for programming one or more of the processors to perform a method for interaction of a user in a scenario of an on-line community, the scenario for modifying the behavior of the user, the method comprising:
providing an avatar, the actions of the avatar commandable by the user within the scenario of the on-line community;
the scenario presenting a representation of an environment conducive to an undesired act of the user; and
enabling the user to direct the avatar to perform and to not perform the undesired act.

20. The one or more processor readable storage devices method of claim 19, the readable code for programming one or more of the processors to perform a method for interaction of a user in a scenario of an on-line community, the scenario for modifying the behavior of the user, the method further comprising rewarding the user with a positive outcome when the avatar does not perform the undesired act.
